(19) United States
(12) Patent Application Publication
(10) Pub. No.: US 2018/0176901 A1
(43) Pub. Date: Jun. 21, 2018

(54) PADDING FOR TRIGGER RESPONSE

(71) Applicant: INTEL IP CORPORATION, SANTA CLARA, CA (US)

(72) Inventors: Po-Kai HUANG, Santa Clara, CA (US); Yaron ALPERT, Petah Tikva (IL); Chittabrata GHOSH, Fremont, CA (US); Robert STACEY, Portland, OR (US)

(21) Appl. No.: 15/383,440

(22) Filed: Dec. 19, 2016

(51) Int. Cl. H04W 72/04; H04L 1/00

(52) U.S. Cl. CPC H04W 72/0413; H04W 84/12; H04L 1/0008

(57) ABSTRACT

A Trigger may be carried in a DL MU PPDU to solicit an UL BA. Then, the AP sends out the following transmission in SIFS time based on the UL BA information. There are numerous situations however where the AP should process the information transmitted (in UL) by multiple STAs and respond to them within the SIFS time. Some AP implementations (in particular the ones that do not use massive hardware (VLSI) accelerators) may not be able to finish the process within the SIFS time due to a very long PHY (Physical Layer) transmission decoding time (e.g., 802.11ax is 16 uS symbols vs 4 uS in legacy IEEE 802.11) and long PHY and MAC information possessing.

### TECHNICAL FIELD

An exemplary aspect is directed toward communications systems. More specifically an exemplary aspect is directed toward wireless communications systems and even more specifically to interference management in wireless networks. Even more particularly, an exemplary aspect is directed toward padding for a Trigger response.

### BACKGROUND

Wireless networks are ubiquitous and are commonplace indoors and outdoors and in shared locations. Wireless networks transmit and receive information utilizing varying techniques and protocols. For example, but not by way of limitation, common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

IEEE 802.11AC and other standards have proposed full duplex Wi-Fi radios that can simultaneously transmit and receive on the same channel using standard Wi-Fi 802.11ac PHYs. These radios achieve close to the theoretical doubling of throughput in all practical deployment scenarios.

Bluetooth® is a wireless technology standard adapted to exchange data over, for example, short distances using short-wavelength UHF radio waves in the ISM band from 2.4 to 2.485 GHz. Bluetooth® is commonly used to communicate information from fixed and mobile devices and for building personal area networks (PANs). Bluetooth® Low Energy (BLE), also known as Bluetooth® Smart®, utilizes less power than Bluetooth® but is able to communicate over the same range as Bluetooth®.

Wi-Fi (IEEE 802.11) and Bluetooth® are somewhat complementary in their applications and usage. Wi-Fi is usually access point-centric, with an asymmetrical client-server connection with all traffic routed through the access point (AP), while Bluetooth® is typically symmetrical, between two Bluetooth® devices. Bluetooth® works well in simple situations where two devices connect with minimal configuration like the press of a button, as seen with remote controls, between devices and printers, and the like. Wi-Fi tends to operate better in applications where some degree of client configuration is possible and higher speeds are required, especially for network access through, for example, an access node. However, Bluetooth® access points do exist and ad-hoc connections are possible with Wi-Fi though not as simply configured as Bluetooth®.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary Trigger frame flow;

FIG. 2 illustrates examples of UL control signalling reports;

FIG. 3 illustrates how a Trigger may also be carried in a DL MU PPDU;

FIG. 4 illustrates the packet extension option defined for the PPDU of the UL response;

FIG. 5 illustrates how the AP can control the duration of the UL response;

FIG. 6 illustrates an exemplary Trigger frame format.

FIG. 7 illustrates a block diagram of components for performing the techniques disclosed herein; and

FIG. 8 is a flowchart illustrating an exemplary method for managing padding for a Trigger frame/response.

### DESCRIPTION OF EMBODIMENTS

A recent revision of the IEEE 802.11ax standard has defined a new mechanism for MU (Multi User) transmissions based on resource allocation signalling (using SIG B for DL (downlink) signalling and a Trigger frame for UL (uplink) signalling). (The DL resource allocation signalling SIG B field can be 1 or more symbols long. In a multi-user transmission, the SIG-B signals the MCS (Modulation and Coding Scheme) for each user. In a single-user transmission, the MCS is signalled in the SIG-A field of the omni-directional portion of the preamble. Therefore, in a single-user transmission, the SIG-B symbol transmitted is an exact repetition of the first LTF (channel estimation)).

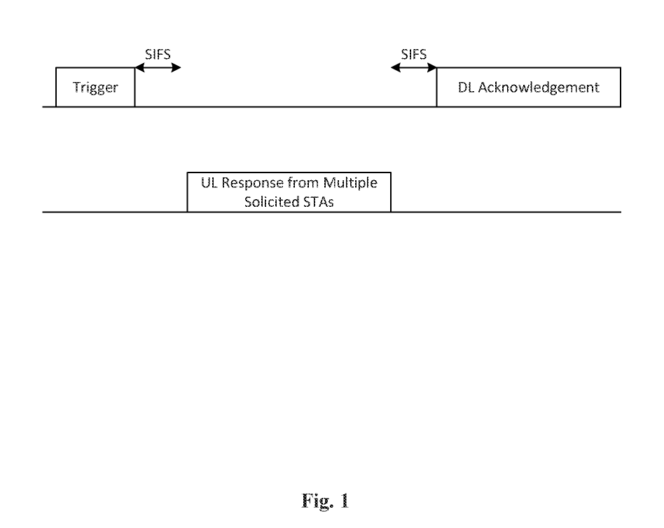

In UL, IEEE 802.11ax has defined a basic Trigger frame flow for an AP (Access Point) to allocate resources to solicit an UL response as shown in FIG. 1 from multiple users.

Note that in FIG. 1, the DL acknowledgment is optional and is only needed if there is data in UL response. Assuming that the AP did not restricted the response by using a spatial type of TF (Trigger Frame), in the data response, each solicited STA (Station) has the freedom to append any data frame, control frame, and/or management frame. Then AP needs to process the UL data response and send out a DL acknowledgment within the SIFS time in the case where the DL acknowledgment is needed. The AP can initiate other transmissions in the situation where the DL acknowledgment is not needed. (Short Interframe Space (SIFS), is the amount of time in microseconds required for a wireless interface to process a received frame and to respond with a response frame. SIFS is the difference in time between the first symbol of the response frame in the air and the last symbol of the received frame in the air. A SIFS time includes the delay in receiver RF, PLCP delay and the MAC processing delay, which depends on the physical layer used. In IEEE 802.11 networks, SIFS is the interframe spacing prior to transmission of an acknowledgment, a Clear To Send (CTS) frame, a block ACK frame that is an immediate response to either a block ACK request frame or an A-MPDU (MAC Protocol Data Unit), the second or subsequent MPDU of a fragment burst, a station responding to any polling a by point coordination function and during contention free periods of point coordination function.)

For example, when the DL acknowledgment is not needed, the defined Trigger frame can also be used to solicit one or more UL control signalling reports such as: a channel availability report, a channel quality report, a buffer status report, and/or the like. Then, the AP sends out the Trigger frame or DL MU frame for the following MU transmission, based on the report information, within the SIFS time as well.

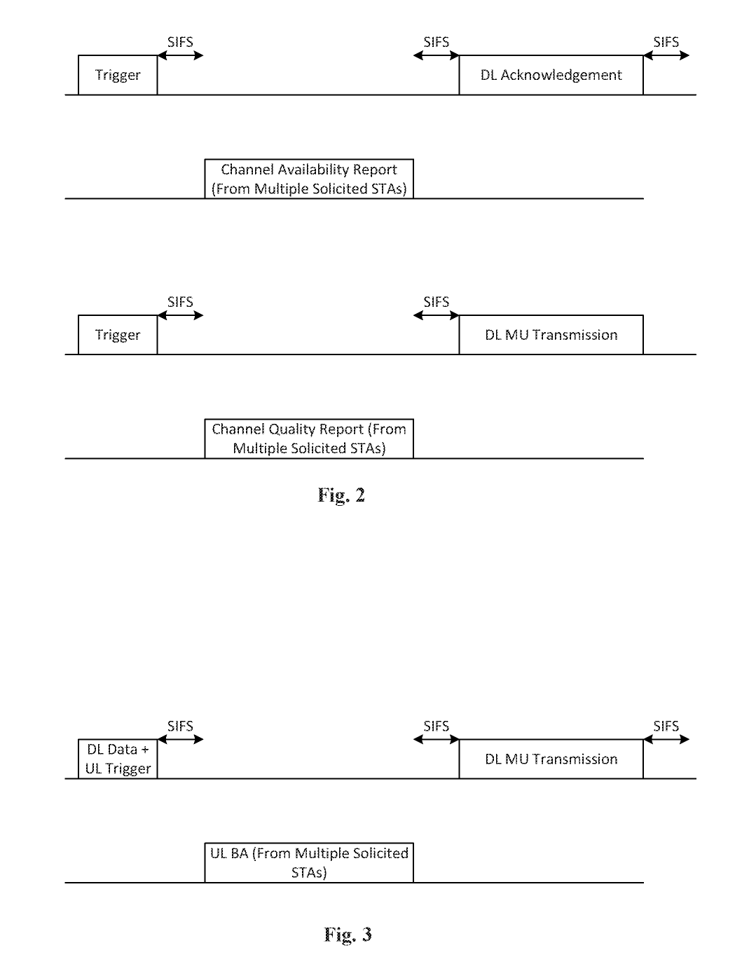

Examples are shown in FIG. 2 of a channel availability report and a channel quality report.

The Trigger may also be carried in a DL MU PPDU to solicit UL BA (Block Acknowledgement). Then, as shown in FIG. 3, the AP sends out the following transmission in SIFS time based on the UL BA information.

There are a numerous cases however where the AP should processes the information transmitted (in UL) by multiple STAs and respond to them within the SIFS time. Some AP implementations (in particular the ones that do not use massive hardware (VLSI) accelerators) may not be able to finish the process within the SIFS time due to a very long PHY (Physical Layer) transmission decoding time (e.g., 802.11ax is 16 uS symbols vs 4 uS in legacy IEEE 802.11) and long PHY and MAC information possessing (for example—stirring matrices generation UL acknowledgment possessing, etc.).

Specifically, there may be up to a 74 channel availability report and/or a channel quality report and/or an acknowledgment frame from 74 different STAs. Processing this huge amount of information and deciding the allocation for the following UL and DL MU transmission may require a time longer than SIFS.

One exemplary embodiment is directed toward adding a common and/or per STA/group of STAs padding request signalling to request an additional padding duration (defined in bits and/or in time) in the UL response to the Trigger frame. The padding request signalling can optionally be advertised and/or pre-negotiated and/or indicated in the immediate resource allocation entity (for example the Trigger frame).

The padding signalling can indicate MAC padding, PHY padding, or both. The use of MAC padding or PHY padding will result in the same overall result, and it should be appreciated that the MAC padding and PHY padding can be complementary to one another such as when they are redundant. Alternatively, the MAC padding and the PHY padding could be supplemental (or additive) to one another to result in MAC padding+PHY padding.

The additional padding duration can be fixed and/or can be variable based on, for example, specific transmission parameters (for example, number of STAs at specific UL transmission, type of UL transmission information, etc.)

As a result, the AP does not need to process the padding in the padding duration and can utilize the padding duration to have enough time for the following transmission initiated by the AP.

Currently, there is no known approach that can be used to enable the AP to have enough processing time of UL responses or MU UL transmissions within the UL PPDU transmission boundary.

Currently, IEEE 802.11 and the IEEE 802.11 baseline support the following alternatives which can be improved upon:

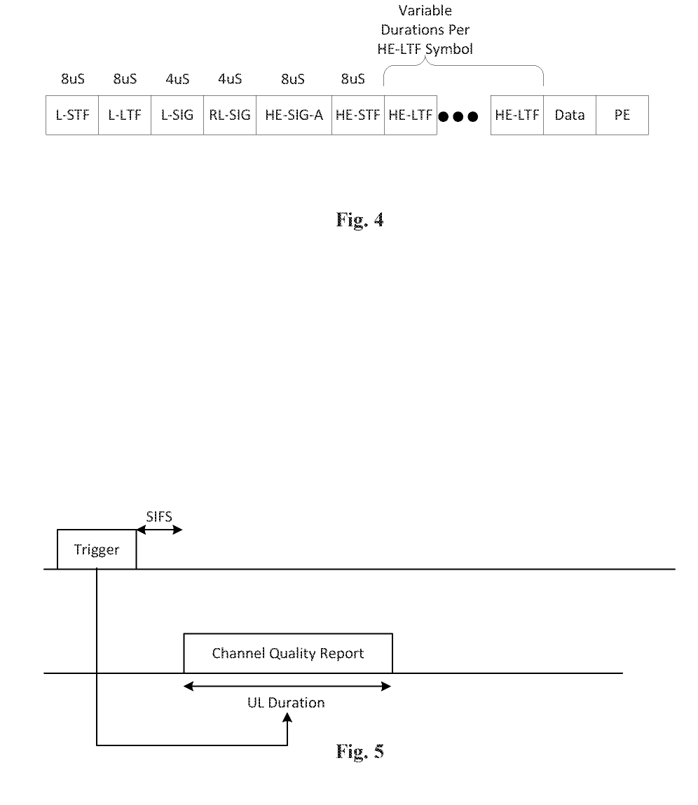

1. Packet Extension
The current IEEE 802.11ax draft defines a “packet extension” mechanism. The packet extension option defined for the PPDU of the UL response is shown in FIG. 4. However, the longest duration of the packet extension is only 16 us, which may not provide enough time for an AP to process the UL response.
In accordance with one exemplary embodiment, the packet extension capability may be redefined and extended for other optional benefits/uses. This option is addressed hereinafter. This packet extension can be a common element for all users.

2. Adding Filler Sequence
An alternative approach is using a filler sequence (like transmission of CTS-to-self or MAC NDP, etc.) but this approach causes a reduction in protocol efficiency (and increases overhead)

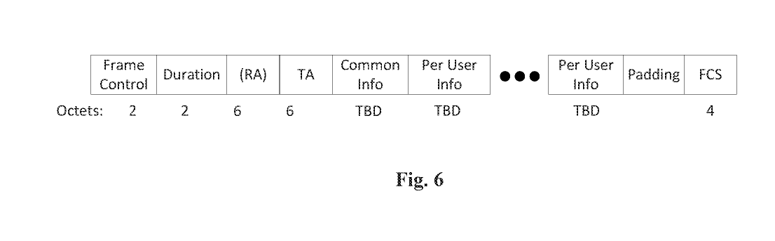

3. Extend the UL Transmission Duration
Simply extending the transmission duration of an UL response does not work due to the following reason. (The AP can control the total transmission duration of the UL response as shown in FIG. 5.)
Based on the current version of the standard, solicited STAs may append any information in the UL MU response as long as the information fits in the UL transmission duration allocated by the Trigger frame for the response. Hence, extending the transmission duration of the UL response implies that the AP may need to process more information, which compounds the problem for the AP not having enough time to respond following the Trigger frame or DL MU transmission. Another option is reducing the UL MCS such that less information is sent by the station with a reduction in efficiency.

4. Limit the UL Type of Information
It is possible that an AP may limit the type of information that can be responded, i.e., channel quality report or channel availability report and then extend the UL response duration. However, these approaches only work if AP is certain that the UL response will not exceed a certain UL transmission duration. An exemplary optional embodiment adds this option as an alternative or in addition to the padding duration.

Two exemplary options that at least address the above shortcomings provide enough time for the AP to process the response to the Trigger frame and prepare the following Trigger frame or DL MU transmission. Note that the following option addresses a specific solution based on specifying MAC and/or PHY padding for the TF response.

Option 1:

Specifying the transmission duration of padding for the Trigger frame or define the maximum UL transmission information duration

The padding option could be MAC padding and/or PHY padding

For MAC padding, the STA can follow the procedure defined in IEEE 802.11-2012 and IEEE 802.11ac-2013, Section 10.13.6 (A-MPDU padding for VHT PPDU). This is the procedure defined for the padding of an UL MU response. Here, the STA simply pads a series of zeros or ones after the last frame. This option assumes that the AP knows the UL transmission duration of the padding so that the AP does not need to decode the padding.

For PHY padding, this provides the additional option of a packet extension. Non-limiting examples include, for example, 32 us or 64 us, however any value can be used. Here, the STA simply adds additional symbols at the end of the packet. This technique can work because the AP knows the exact information for UL response.

Several approaches to specify the duration of padding for Trigger frame are presented herein. The first is specifying the duration used for padding in the common info field of Trigger frame. The UL transmission duration can be used for MAC padding or PHY padding. The duration can also be specified in the per-user info field of the Trigger frame. The second is for specifying the UL transmission duration used for actual transmission in the common info field of Trigger frame, the padding UL transmission duration is then equal to UL transmission duration minus the duration of actual UL transmission. The duration can be specified in the per-user info field of the Trigger frame as well.

The third is specifying the padding duration based on the indication for the packet extension. This is used for PHY padding option. The fourth is negotiating the padding UL transmission duration with each STA beforehand for the UL response. For example, the padding transmission duration can be STA dependent and can be especially useful if the TF format is not changeable.

To decide when to use MAC or PHY padding, the one exemplary embodiment relies upon a standard specifying the one padding option. For another exemplary embodiment, a standard could also define that if there are data portions in the UL Trigger based PPDU, then MAC padding is used. If there are no data portions in the UL Trigger based PPDU, then PHY padding is used.

FIG. 6 illustrates an exemplary Trigger frame format. While certain optional fields with certain lengths in a certain order are shown, it is to be appreciated that the fields, lengths and order can be changed from what is shown. The Trigger frame format includes a frame control field, a duration field, an optional (RA) field (address of STA recipient), TA field (address of STA transmitting the Trigger frame, a Common Info field, one or more per user info fields, a padding field and a FCS.

The Common Info field includes a length field, a cascade information field, a HE-SIG-A Info field, a CP and LTF type field a Trigger type field and a Trigger Dependent Common Info field. The Length subfield of the Common Info field indicates the value of the L-SIG Length field of the HE Trigger-based PPDU that is the response to the Trigger frame. If the Cascade Indication subfield is 1, then a subsequent Trigger frame follows the current Trigger frame. Otherwise the Cascade Indication subfield is 0. The HE-SIG-A Info subfield of the Common Info field indicates the content of the HE-SIG-A field of the HE Trigger-based PPDU response. The number of bits in HE-SIG-A of the HE Trigger-based PPDU that may be implicitly known by all responding STAs can be excluded. The CP and LTF Type subfield of the Common Info field indicates the CP and HE-LTF type of the HE Trigger-based PPDU response. The Trigger Type subfield indicates the type of the Trigger frame. The Trigger frame can include an optional type-specific Common Info and optional type-specific Per User Info.

The Per User information field also includes several optional subfields. Specifically, the Per User Info field includes the User Identifier subfield and indicates the AID of the STA allocated the RU (Resource Unit) to transmit the MPDU(s) in the HE (High Efficiency) Trigger-based PPDU. The RU Allocation subfield of the Per User Info field indicates the RU used by the HE Trigger-based PPDU of the STA identified by User Identifier subfield. The length and coding of RU Allocation subfield are to be determined. The Coding Type subfield of the Per User Info field indicates the code type of the HE Trigger-based PPDU response of the STA identified by User Identifier subfield. The MCS (Modulation and Coding Scheme) subfield of the Per User Info field indicates the MCS of the HE Trigger-based PPDU response of the STA identified by User Identifier field. The DCM subfield of the Per User Info field indicates dual carrier modulation of the HE Trigger-based PPDU response of the STA identified by User Identifier subfield. The SS Allocation subfield of the Per User Info field indicates the spatial streams of the HE Trigger-based PPDU response of the STA identified by User Identifier field.

In accordance with the first option, the Common Info field is modified to include the transmission duration information as discussed herein. This transmission duration information can be any one or more of the uplink transmission duration, a field or subfield with duration information and/or a field with the actual transmission duration.

For the second option, discussed shortly, the Per User Info field can be replicated a number of times, one for each STA. The padding can be different for different STAs. However, since the AP knows the duration, the indication of the duration could be as simple as one bit in the Common Info field. For example, the one bit could represent “Please Don't Aggregate Message.” However, it is to be appreciated at any number of bit(s) could be used to represent any message as discussed herein.

For this second option, the Trigger frame limits the response to a specific type of response. For example, the channel quality report response, the beam forming report response, and/or the channel availability report response, as examples. A specific type of Trigger can be defined to achieve this purpose. For example, a Trigger frame can be defined that only Triggers the channel quality report and/or the beam forming report and/or the channel availability report and/or any other control response report. Here, the STA is only allowed to transmit the control frame based on the restriction of the Trigger frame, and the length of control frame is fixed. The Trigger frame can extend the UL duration such that the UL duration is longer than the required duration to transmit one control response. STAs are then requested to do the padding if STA does not have anything else to send.

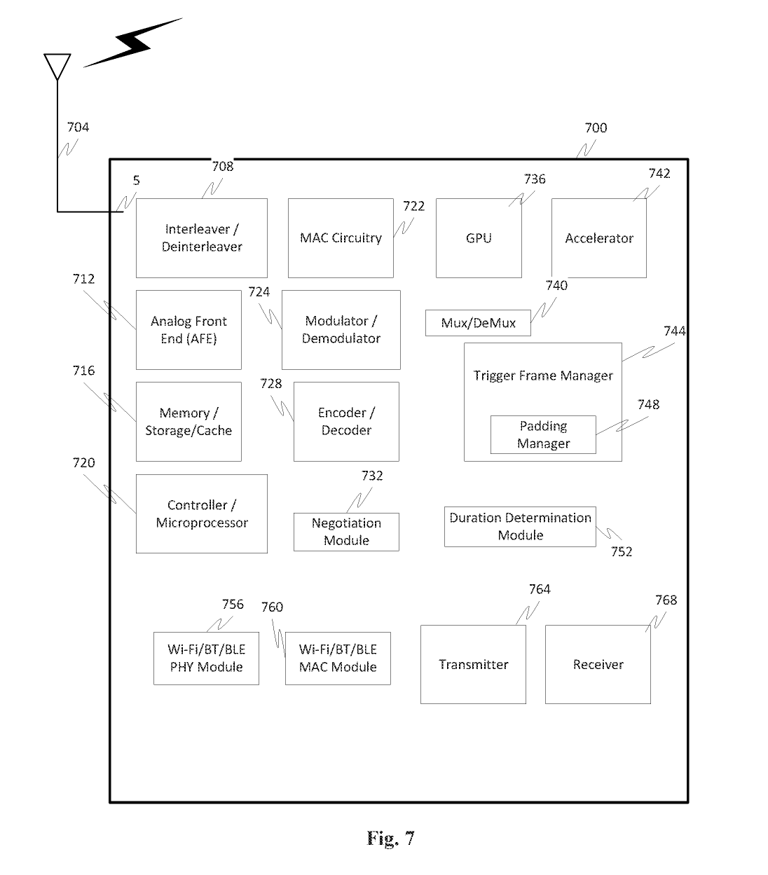

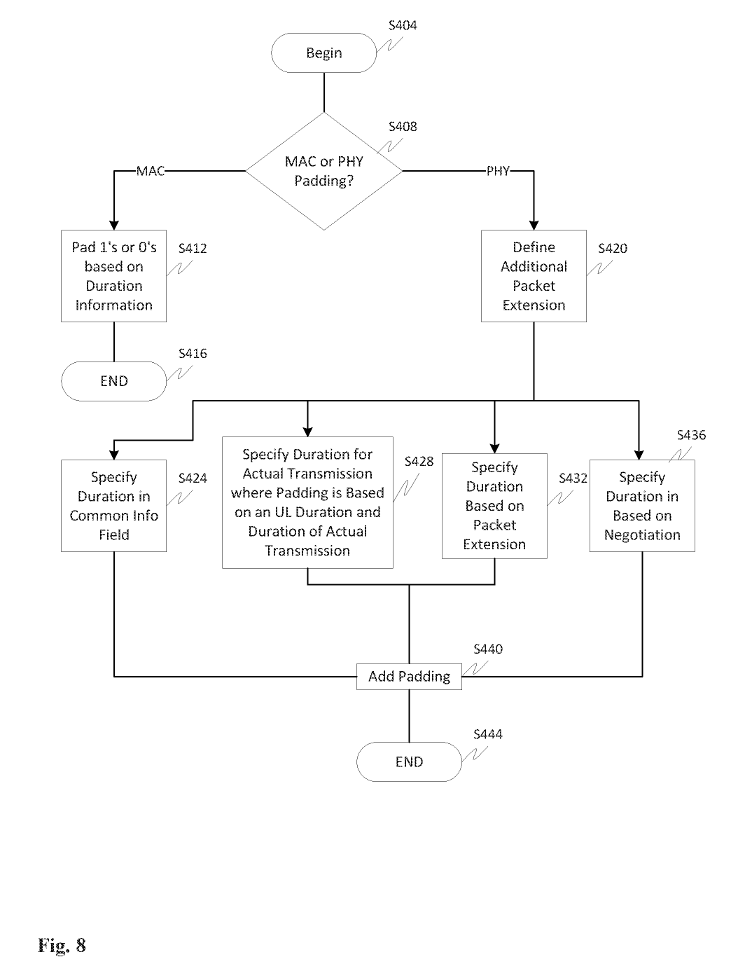

FIG. 7 illustrates an exemplary hardware diagram of a device 700, such as a wireless device, mobile device, access point, station, and/or the like, that is adapted to implement the technique(s) discussed herein. Operation will be discussed in relation to the components in FIG. 7 appreciating that each separate device in a system, e.g., station, AP, proxy server, etc., can include one or more of the components shown in the figure, with the components each being optional.

In addition to well-known componentry (which has been omitted for clarity), the device 700 includes interconnected elements (with links 5 omitted in some instances for clarity) including one or more of: one or more antennas 704, an interleaver/deinterleaver 708, an analog front end (AFE) 712, memory/storage/cache 716, controller/microprocessor 720, MAC circuitry 722, modulator/demodulator 724, encoder/decoder 728, signal strength measurer negotiation module 732, GPU 736, accelerator 742, a multiplexer/demultiplexer 740, trigger frame manager 744, padding manager 748, duration determination module 752, Wi-Fi/BT/BLE PHY module 756, a Wi-Fi/BT/BLE MAC module 760, transmitter 764 and receiver 768. The various elements in the device 700 are connected by one or more links (not shown, again for sake of clarity).

The device 700 can have one more antennas 704, for use in wireless communications such as multi-input multi-output (MIMO) communications, multi-user multi-input multi-output (MU-MIMO) communications Bluetooth®, LTE, RFID, 4G, LTE, etc. The antenna(s) 704 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 704 generally interact with the Analog Front End (AFE) 712, which is needed to enable the correct processing of the received modulated signal and signal conditioning for a transmitted signal. The AFE 712 can be functionally located between the antenna and a digital baseband system in order to convert the analog signal into a digital signal for processing and vice-versa.

The device 700 can also include a controller/microprocessor 720 and a memory/storage/cache 716. The device 700 can interact with the memory/storage/cache 716 which may store information and operations necessary for configuring and transmitting or receiving the information described herein. The memory/storage/cache 716 may also be used in connection with the execution of application programming or instructions by the controller/microprocessor 720, and for temporary or long term storage of program instructions and/or data. As examples, the memory/storage/cache 720 may comprise a computer-readable device, RAM, ROM, DRAM, SDRAM, and/or other storage device(s) and media.

The controller/microprocessor 720 may comprise a general purpose programmable processor or controller for executing application programming or instructions related to the device 700. Furthermore, the controller/microprocessor 720 can perform operations for configuring and transmitting information as described herein. The controller/microprocessor 720 may include multiple processor cores, and/or implement multiple virtual processors. Optionally, the controller/microprocessor 720 may include multiple physical processors. By way of example, the controller/microprocessor 720 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 700 can further include a transmitter 764 and receiver 768 which can transmit and receive signals, respectively, to and from other wireless devices and/or access points using the one or more antennas 704. Included in the device 700 circuitry is the medium access control or MAC Circuitry 722. MAC circuitry 722 provides for controlling access to the wireless medium. In an exemplary embodiment, the MAC circuitry 722 may be arranged to cooperate with the MAC module 760 to contend for the wireless medium and configure frames or packets for communicating over the wireless medium.

The PHY Module/Circuitry 756 controls the electrical and physical specifications for device 700. In particular, PHY Module/Circuitry 756 manages the relationship between the device 700 and a transmission medium. Primary functions and services performed by the physical layer, and in particular the PHY Module/Circuitry 756, include the establishment and termination of a connection to a communications medium, and participation in the various process and technologies where communication resources shared between, for example, among multiple STAs/APs. These technologies further include, for example, contention resolution and flow control and modulation or conversion between a representation digital data in user equipment and the corresponding signals transmitted over the communications channel. These are signals are transmitted over the physical cabling (such as copper and optical fiber) and/or over a radio communications (wireless) link. The physical layer of the OSI model and the PHY Module/Circuitry 156 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 122 handle co-ordination of interactions between the MAC and PHY layers.

The interleaver/deinterleaver 708 cooperates with the various PHY components to provide Forward Error correction capabilities. The modulator/demodulator 724 similarly cooperates with the various PHY components to perform modulation which in general is a process of varying one or more properties of a periodic waveform, referred to and known as a carrier signal, with a modulating signal that typically contains information for transmission. The encoder/decoder 728 manages the encoding/decoding used with the various transmission and reception elements in device 700.

The MAC layer and components, and in particular the MAC module 760 and MAC circuitry 722 provide functional and procedural means to transfer data between network entities and to detect and possibly correct errors that may occur in the physical layer. The MAC module 760 and MAC circuitry 722 also provide access to contention-based and contention-free traffic on different types of physical layers, such as when multiple communications technologies are incorporated into the device 700. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 700 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The accelerator 742 can cooperate with MAC circuitry 722 to, for example, perform real-time MAC functions. The GPU 736 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

In operation the device 700 and in particular the trigger frame manager/circuitry 744, padding manager/circuitry 748, and optionally the processor 720 and memory 716 specify the duration of the padding for the trigger frame. The trigger frame manager/circuitry 744 can be, for example, software and corresponding processor/memory, an ASIC, a System on a Chip, or in general any hardware and/or software capable of performing the described functionality. Similarly, the padding manager/circuitry 748 can be, for example, software and corresponding processor/memory, an ASIC, a System on a Chip, or in general any hardware and/or software capable of performing the described functionality.

As discussed, this padding could be MAC padding or PHY padding. For MAC padding, the STA, with the assistance of the duration determination module 752, pads a series of zeros or ones after a last frame. As the AP knows the duration of the padding, the AP does not need to decode the padding.

For PHY padding, an additional packet extension is defined based on duration information, such as the duration of the actual transmission as determined by the duration determination module. Here, the STA adds symbols at the end of the packet for the needed duration.

The duration determination module 752 is capable of determining and setting the duration in accordance with several exemplary techniques. The first is specifying the duration used for padding in the common info field of Trigger frame. The duration can be used for either the MAC padding or the PHY padding technique. The duration can also be specified in the per-user info field of the Trigger frame.

The second technique specifies the duration used for actual transmission in the common info field of Trigger frame where the padding duration is equal to the UL duration minus the duration of an actual transmission. This duration can be specified in, for example, the per-user info field of the Trigger frame.

The third technique specifies the padding duration based on an indication of a packet extension. This technique is especially useful for the PHY padding option. The fourth technique is accomplished with the cooperation of the negotiation module 732 where the padding duration is negotiated with each STA beforehand for the UL response. For example, the padding duration can be STA dependent and can be especially useful if the TF format is not changeable.

To decide when to use MAC or PHY padding, the one exemplary embodiment relies upon, for example, a standard or a specification specifying which padding option is to be used. For another exemplary embodiment, a standard or a specification could also define that if there are data portions in the UL Trigger based PPDU, then MAC padding is to be used. If there are no data portions in the UL Trigger based PPDU, then PHY padding could be specified as being used.

In accordance with this first option, the Common Info field is modified to include the duration information as established by the duration determination module 752 as discussed herein. This duration information can be any one or more of the uplink duration, a field or subfield with duration information and/or a field with the actual transmission duration information.

For the second option, the Trigger frame, as managed by the trigger frame manager 744, limits the response to a specific type of response. For example, the channel quality report response, the beam forming report response, and/or the channel availability report response, as examples. A specific type of Trigger can be defined to achieve this purpose. For example, a Trigger frame can be defined that only Triggers the channel quality report and/or the beam forming report and/or the channel availability report and/or any other control response report. Here, the STA is only allowed to transmit the control frame based on the restriction as specified in the Trigger frame, and the length of the control frame is fixed. The Trigger frame can extend the UL duration such that the UL duration is longer than the required duration to transmit one control response. STAs are then requested to do the padding if the STA does not have anything else to send.

Here, the Per User Info field can be replicated a number of times, one for each STA. The padding can be different for different STAs. However, since the AP knows the duration, the indication of the duration could be as simple as one bit in the Common Info field. For example, the one bit could represent “Please Don't Aggregate Message.” However, it is to be appreciated at any number of bit(s) could be used to represent any message as discussed herein.

FIG. 8 outlines an exemplary method for managing padding. In particular, control begins in step S800 and continues to step S804.

As discussed, this padding could be MAC padding or PHY padding. In step S408, a determination is made whether MAC or PHY padding is to be used. For MAC padding, control continues to step S412 with control otherwise continuing to step S420. In step S416, a series of zeros or ones are padded after a last frame. Since, as discussed, the AP knows the duration of the padding, the AP does not need to decode the padding. Control then continues to step S416 where the control sequence ends.

In step S420, and for PHY padding, an additional packet extension is defined based on duration information, such as the duration of an actual transmission. Here, a STA will add one or more symbols at the end of the packet for the needed duration.

As discussed, there are several exemplary techniques for determining and setting the duration. The first, in step S424, specifies the duration used for padding in the common info field of a Trigger frame. As discussed, the duration information can be used for either the MAC padding or the PHY padding technique. The duration can also be specified in the per-user info field of the Trigger frame. This duration information can be any one or more of the uplink duration, a field or subfield with duration information and/or a field with the actual transmission duration information.

Step S428 shows a second technique which specifies the duration used for actual transmission in the common info field of the Trigger frame where the padding duration is equal to the UL duration minus the duration of an actual transmission. This duration can be specified in, for example, the per-user info field of the Trigger frame.

Step S432 shows a third technique which specifies the padding duration based on an indication of a packet extension. This technique can be especially useful for the PHY padding option.

The fourth technique, in step S436, specifies that the padding duration is negotiated with each STA beforehand for the UL response. For example, the padding duration can be determined on a STA by STA basis, and can be especially useful if the TF format is not changeable.

Control for each step then continues to step S440 where the padding is added with control continuing to step S444 where the control sequence ends.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:
A wireless communications device comprising:
   a uplink (UL) transmission duration determination module to determine a UL transmission duration of padding or a maximum transmission duration for a response to a Trigger frame, the Trigger frame to be transmitted from the wireless communications device to another wireless device;
a trigger frame manager and processor configured to indicate the UL transmission duration of the padding or maximum transmission duration for the response to the Trigger frame in the Trigger frame; and
a transmitter to transmit the Trigger frame with the indication of the padding.
Any of the above aspects, wherein the UL transmission duration of the padding is for MAC (Media Access Control) padding or PHY (Physical Layer) padding.
Any of the above aspects, wherein the UL transmission duration of the padding is based on a total response duration.
Any of the above aspects, wherein the UL transmission duration of the padding is specified in a common info field.
Any of the above aspects, wherein the UL transmission duration of the padding is based on: a packet extension, signaling and or a station indication of what is needed.
Any of the above aspects, further comprising a negotiation module to negotiate UL transmission duration of the padding prior to an uplink response.
Any of the above aspects, wherein the UL transmission duration for the padding is signaled by an indicated total response duration minus an indicated duration of actual data transmission.
Any of the above aspects, wherein the duration of the padding is specified in a per-user field of the Trigger frame.
Any of the above aspects, wherein the Trigger frame specifies a restricted type of response for a solicited station to respond.
Any of the above aspects, wherein the device operates to indicate a total response UL transmission duration with value that is equal to the required time to transmit the restricted type of response plus a sufficient time for the device to process one or more responses to a Trigger frame.
A non-transitory information storage media having stored thereon one or more instructions, that when executed by one or more processors, cause a wireless device to perform a method comprising:
determining a UL transmission duration of padding for a response to a Trigger frame, the Trigger frame to be transmitted from the wireless communications device to another wireless device;
indicating the UL transmission duration of the padding for the response to the Trigger frame in the Trigger frame; and
transmitting the Trigger frame with the indication for the padding.
Any of the above aspects, wherein the UL transmission duration of the padding is for MAC (Media Access Control) padding or PHY (Physical Layer) padding.
Any of the above aspects, wherein the UL transmission duration of the padding is based on a total response duration.
Any of the above aspects, wherein the UL transmission duration of the padding is specified in a common info field.
Any of the above aspects, wherein the UL transmission duration of the padding is based on a packet extension.
Any of the above aspects, further comprising a negotiation module to negotiate the UL transmission duration of the padding prior to an uplink response.
Any of the above aspects, wherein the UL transmission duration of the padding is signaled by an indicated total response duration minus an indicated duration of actual UL data transmission.
Any of the above aspects, wherein the UL transmission duration of the padding is specified in a per-user field of the Trigger frame.
Any of the above aspects, wherein the Trigger frame specifies a restricted type of response for a solicited station to respond.
A wireless communications device comprising:
means for determining a duration for padding for a response to a Trigger frame, the Trigger frame to be transmitted from the wireless communications device to another wireless device;
means for indicating the duration of the padding for the response to the Trigger frame in the Trigger frame; and
means for transmitting the Trigger frame with the indication for the padding.
A wireless communications device comprising:
a receiver to receive a Trigger frame, the Trigger frame including an indication of a duration of padding for a response to the Trigger frame; and
a padding manager and a transmitter to transmit the response to the Trigger frame with the padding.
Any of the above aspects, wherein the duration for the padding is for MAC (Media Access Control) padding or PHY (Physical Layer) padding.
Any of the above aspects, wherein the duration for the padding is based on a total response duration.
Any of the above aspects, wherein the duration for the padding is specified in a common info field.
Any of the above aspects, wherein the duration of the padding is based on a packet extension.
Any of the above aspects, further comprising a negotiation module to negotiate the duration for the padding prior to an uplink response.
Any of the above aspects, wherein the duration of the padding is signaled by an indicated total response duration minus an indicated duration of actual data transmission.
Any of the above aspects, wherein the duration of the padding is specified in a per-user field of the Trigger frame.
Any of the above aspects, wherein the Trigger frame specifies a restricted type of response for a solicited station to respond.
Any of the above aspects, wherein the device operates to indicate a total response duration with value that is equal to the required time to transmit the restricted type of response plus a sufficient time for the device to process one or more responses to a Trigger frame.
A wireless communications device comprising:
means for receiving a Trigger frame, the Trigger frame including an indication of a duration of padding for a response to the Trigger frame; and
means for transmitting the response to the Trigger frame with the padding.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, circuitry, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, IEEE 802.11ay, Wi-Fi, LTE, 4G, Bluetooth®, WirelessHD, WiGig, WiGi, 3GPP, Wireless LAN, WiMAX, DensiFi SIG, Unifi SIG, 3GPP LAA (licensed-assisted access), and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhancing and improving communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a uplink (UL) transmission duration determination module to determine a UL transmission duration of padding or a maximum transmission duration for a response to a Trigger frame, the Trigger frame to be transmitted from the wireless communications device to another wireless device;
a trigger frame manager and processor configured to indicate the UL transmission duration of the padding or maximum transmission duration for the response to the Trigger frame in the Trigger frame; and
a transmitter to transmit the Trigger frame with the indication of the padding.

2. The device of claim 1, wherein the UL transmission duration of the padding is for MAC (Media Access Control) padding or PHY (Physical Layer) padding.

3. The device of claim 1, wherein the UL transmission duration of the padding is based on a total response duration.

4. The device of claim 1, wherein the UL transmission duration of the padding is specified in a common info field.

5. The device of claim 1, wherein the UL transmission duration of the padding is based on: a packet extension, signaling and or a station indication of what is needed.

6. The device of claim 1, further comprising a negotiation module to negotiate UL transmission duration for the padding prior to an uplink response.

7. The device of claim 1, wherein the UL transmission duration of the padding is signaled by an indicated total response duration minus an indicated duration of actual data transmission.

8. The device of claim 1, wherein the duration of the padding is specified in a per-user field of the Trigger frame.

9. The device of claim 1, wherein the Trigger frame specifies a restricted type of response for a solicited station to respond.

10. The device of claim 9, wherein the device operates to indicate a total response UL transmission duration with value that is equal to the required time to transmit the restricted type of response plus a sufficient time for the device to process one or more responses to a Trigger frame.

11. A non-transitory information storage media having stored thereon one or more instructions, that when executed by one or more processors, cause a wireless device to perform a method comprising:
determining a UL transmission duration of padding for a response to a Trigger frame, the Trigger frame to be transmitted from the wireless communications device to another wireless device;
indicating the UL transmission duration of the padding for the response to the Trigger frame in the Trigger frame; and
transmitting the Trigger frame with the indication of the padding.

12. The media of claim 11, wherein the UL transmission duration of the padding is for MAC (Media Access Control) padding or PHY (Physical Layer) padding.

13. The media of claim 11, wherein the UL transmission duration of the padding is based on a total response duration.

14. The media of claim 11, wherein the UL transmission duration of the padding is specified in a common info field.

15. The media of claim 11, wherein the UL transmission duration of the padding is based on a packet extension.

16. The media of claim 11, further comprising a negotiation module to negotiate the UL transmission duration for the padding prior to an uplink response.

17. The media of claim 11, wherein the UL transmission duration of the padding is signaled by an indicated total response duration minus an indicated duration of actual UL data transmission.

18. The media of claim 11, wherein the UL transmission duration of the padding is specified in a per-user field of the Trigger frame.

19. The media of claim 11, wherein the Trigger frame specifies a restricted type of response for a solicited station to respond.

20. A wireless communications device comprising:
means for determining a duration for padding for a response to a Trigger frame, the Trigger frame to be transmitted from the wireless communications device to another wireless device;
means for indicating the duration of the padding for the response to the Trigger frame in the Trigger frame; and
means for transmitting the Trigger frame with the indication of the padding.
